(19) United States
(12) Patent Application Publication
(10) Pub. No.: US 2003/0095344 A1
(43) Pub. Date: May 22, 2003

(54) Small lens for optical use

(75) Inventors: Takashi Ito, Saitama City (JP); Masayuki Murakami, Saitama City (JP)

Correspondence Address: JORDAN AND HAMBURG LLP, 122 EAST 42ND STREET, SUITE 4000, NEW YORK, NY, 10168, US

(73) Assignee: Fuji Photo Optical Co., Ltd., Saitama City (JP)

(21) Appl. No.: 10/292,336

(22) Filed: Nov. 12, 2002

(30) Foreign Application Priority Data
Nov. 22, 2001 (JP) 2001-357595

(51) Int. Cl. G02B 3/00; G02B 7/00; G02B 9/00

(52) U.S. Cl. 359/811

(57) ABSTRACT

To provide a small lens for optical use which enables a lens per se to be coated easily and securely and to be readily positioned in a lens barrel into which it is mounted subsequently. Either a circumferential shape of a flange is formed polygonally on a plane orthogonal to an optical axis or at least two sides of the flange are formed linearly in a length equal to or longer than a diameter of the lens per se.

### BACKGROUND OF THE INVENTION

1. Field of the Invention

The present invention relates to a small lens for optical use, and more particularly to a small lens for optical use suitable for coating of the lens per se to prevent reflection or some other purpose.

2. Description of the Related Art

To form a small lens for optical use according to the prior art, made of plastic for instance as shown in FIG. 1 through FIG. 4, pelletized plastic material 102 is dried by putting it into a drier 101 of an injection molding unit 100; the plastic material 102 is melted in a cylinder 103; this molten plastic material 102 is injected into a metallic mold 104 using a screw 105; the metallic mold 104 is opened after waiting until it cools down; a pair of gates 108 are provided at a tip of each of runners 107 extending in four directions from a spool 106 as shown in FIG. 5, and a molded lens 200 is formed at the tip of each of the gates 108. In FIG. 5 and FIG. 6, respectively the same reference signs are assigned to what are formed in the positions corresponding to the spool 106, the runners 107 and the gates 108 of the metallic mold 104. A front view of one of these molded lenses 200 is shown in FIG. 7. The diameter of this lens 200 is 3 mm. All around the outer circumference of the lens per se 200A is formed a circular flange 200B, of which one face is referred to as a bearing surface A₁; the other face, as a bearing surface A₂; and the side circumference of the circle is denoted by R. When both faces of the lens per se 200A are to be coated, these bearing surfaces A₁ and A₂ and the side circumference R are supported by coat jigs 110 as illustrated in FIG. 8. In a state in which the lenses 200 are supported by the coat jigs 110, both optically functional faces of the lenses per se 200A are coated by vapor deposition. Then, each of these lenses 200 is fitted to a lens mount 300 in the lens barrel by utilizing the bearing surface A₁ and the side circumference R as shown in FIG. 9.

The coating method and the means for fitting into the lens barrel according to the prior art pose no problem where the thickness and the radial length of the circular flange 200B are sufficiently great, but a small lens of less than 3 mm, or even 2 mm or less, would pose a problem because the area of its bearing surface A₁ becomes too small. As shown in FIG. 10, if a lens 200 of this size is coated (by vapor deposition) while it is supported by coat jigs 110 having the largest hole (φD) compatible with the optically functional face (φF) of the lens per se 200A, the coat on the periphery of the optically functional face will become shadowed. Thus, the coat layer on the periphery of the optically functional face will become thinner than the central part or uneven. Moreover, when the lens 200 is set to the coat jigs 110 by an automatic machine, the lens 200 may not fit stably on account of the small area of its bearing surface A₁, possibly resulting in inclined setting of the lens 200 to the coat jigs 110 and accordingly in faulty coating. Furthermore, when the lens 200 is mounted into the lens barrel after it is coated, the small area of the bearing surface A₁ would make the positioning difficult.

### SUMMARY OF THE INVENTION

In view of these problems, the present invention is intended to provide a small lens for optical use which enables the lens per se to be coated easily and securely and to be readily positioned in the lens barrel into which it is mounted subsequently.

In order to attain the object stated above, in a small lens for optical use having a flange formed around the lens per se according to the present invention, either the circumferential shape of the flange is formed polygonally on a plane orthogonal to the optical axis or at least two sides of the flange are formed linearly in a length equal to or longer than the diameter of the lens per se, and preferably the circumferential shape of the flange should be rectangular.

Since either the circumferential shape of the flange is formed polygonally on a plane orthogonal to the optical axis or at least two sides of the flange are formed linearly in a length equal to or longer than the diameter of the lens per se according to the invention, when the optically functional faces of the lens are to be coated, coating can be accomplished easily and securely by supporting the long flange in the outward extending part of the lens per se with coat jigs. At the time of mounting the lens into the lens barrel, the lens can be prevented from turning within the lens barrel by utilizing one side of the polygon or the linear sides of the flange.

### BRIEF DESCRIPTION OF THE DRAWINGS

FIG. 1 is a schematic diagram of an apparatus for forming a lens by injection molding;

FIG. 2 shows a section in a state immediately before plastic material is injected into a metallic mold;

FIG. 3 shows a section in a state in which the plastic material has been injected into the metallic mold;

FIG. 4 shows a section in a state in which the plastic material has been cooled and solidified and the metallic mold has been opened;

FIG. 5 shows a perspective view of a plastic product taken out of the metallic mold;

FIG. 6 shows a perspective view of a state in which molded products have been removed from the gates;

FIG. 7 shows a front view of a molded lens;

FIG. 8 shows a section in a state in which the molded lens is supported by coat jigs;

FIG. 9 shows a section in a state in which the lens is mounted in a lens barrel;

FIG. 10 is a sectional diagram illustrating an inconvenience suffered in coating a small lens;

FIG. 11 shows a plan of a small lens for optical use according to the present invention;

FIG. 12 show a section of FIG. 11 along a line X-X;

FIG. 13 shows a section of a lens held between the coat jigs;

FIG. 14 shows a plan of a lens mounted in a lens barrel;

FIG. 15 shows a section of FIG. 14 along a line A-A;

FIG. 16 shows a section of FIG. 14 along a line B-B;

FIG. 17 shows a horizontal section of the lens barrel before a lens is mounted therein;

FIG. 18 shows a plan of a lens representing another mode of implementing the present invention; and

FIG. 19 shows a plan of a lens representing still another mode of implementing the present invention in a state in which it is set to coat jigs.

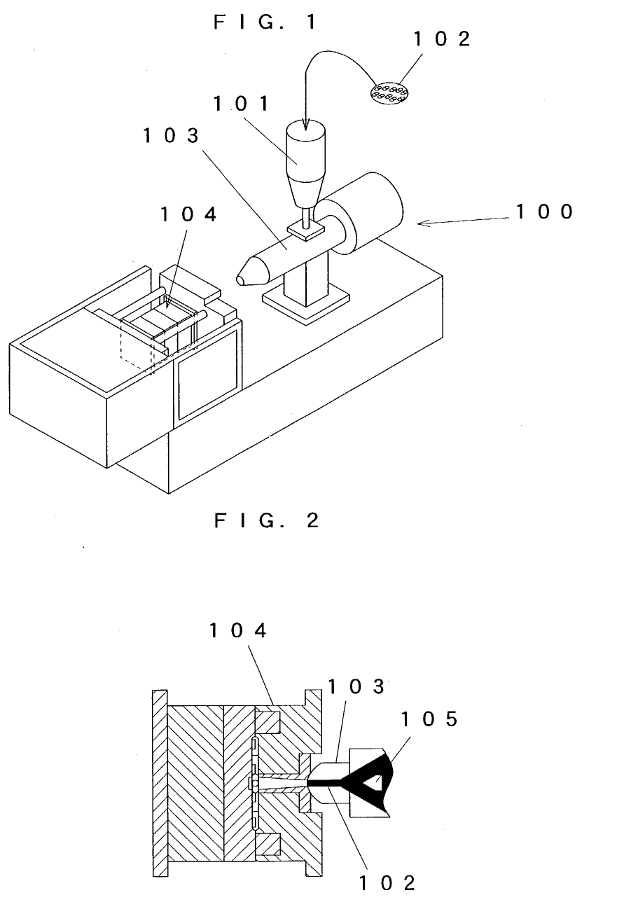

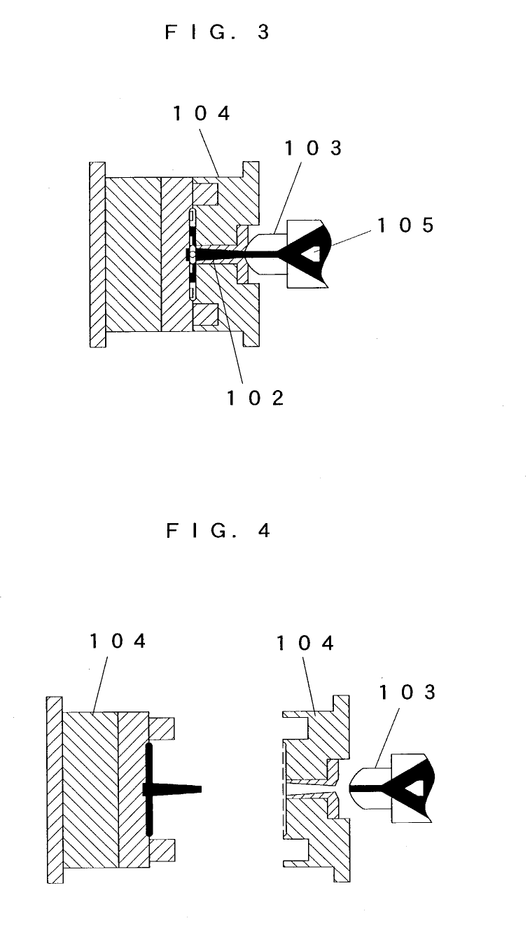

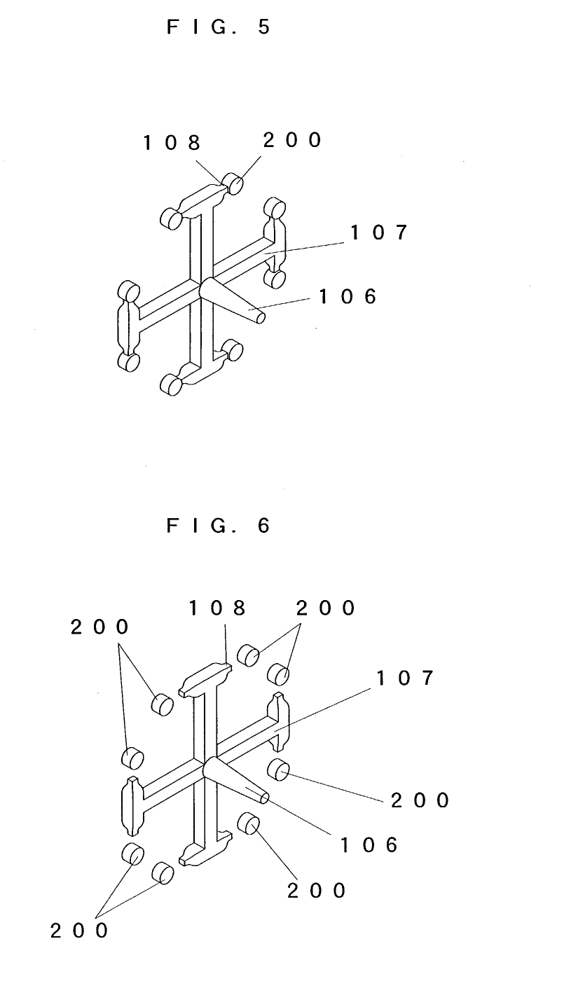

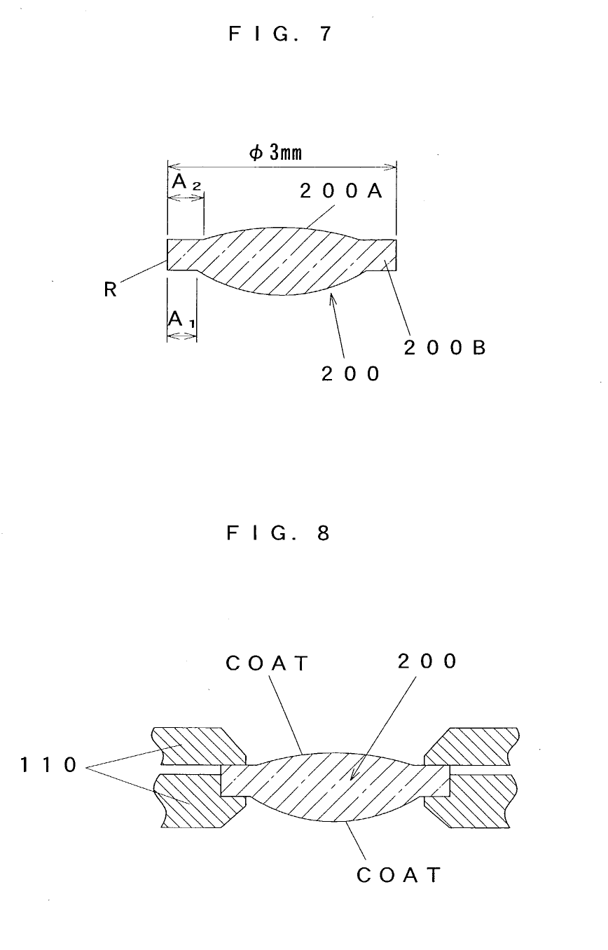

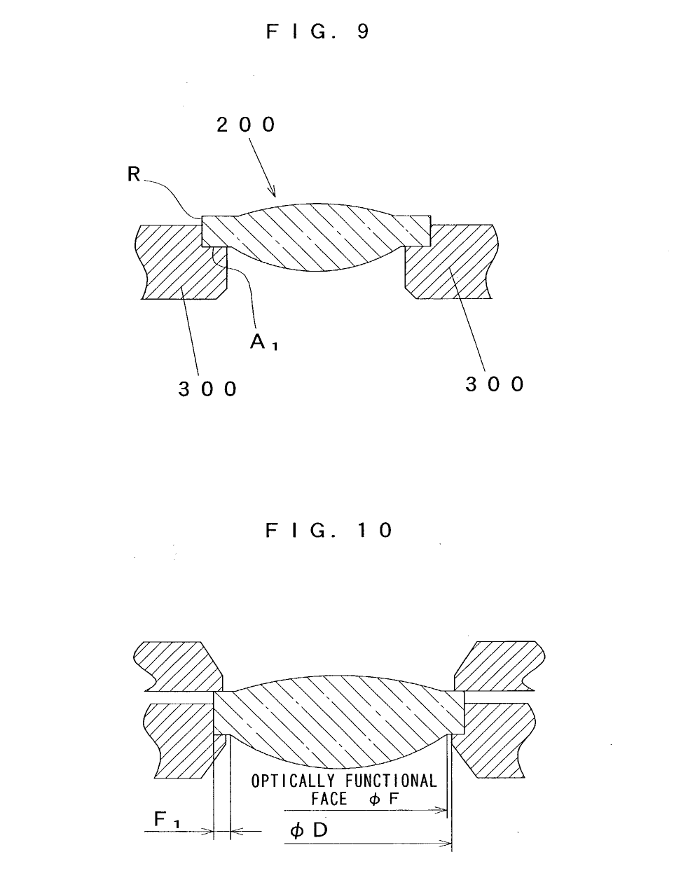

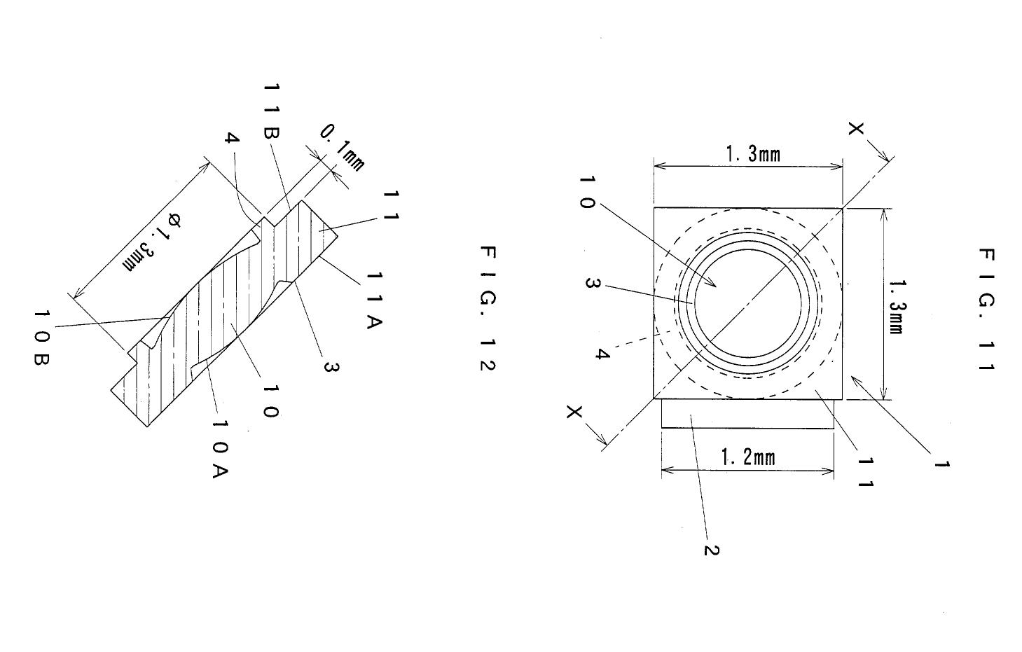

### DESCRIPTION OF THE PREFERRED EMBODIMENTS

Preferred embodiments of the present invention will be described below with reference to the accompanying drawings.

FIG. 11 shows a plan of a lens 1, in which a flange 11 is formed around a lens per se 10, and a circumferential shape of this flange 11 is formed in a square. One side of this square flange 11 constitutes a gate 2. The size of this small lens 1 for optical use is such that each side of the flange 11 is 1.3 mm. Further, each side of the square formed by this flange 11 is tangent to a circle formed by a round body (convex 4) around the lens per se 10.

FIG. 12 show a section of FIG. 11 along a line X-X. Either the top of one optically functional face 10A and that of the periphery 3 are set to be as high or that of the periphery is set higher, the convex 4 is formed on the periphery of the other optically functional face 10B, and the top of this convex 4 is formed higher than (or as high as) that of the optically functional face 10B. The projecting height of this convex 4 from the flange 11 is supposed to be 0.1 mm in this embodiment.

The small lens 1 for optical use shown in FIG. 11 and FIG. 12 is formed from the plastic material 102 by injection molding using the injection molding unit 100 described above.

The upper and lower parts of the flange 11 outward in the radial direction from the round body of the aforementioned convex 4 respectively constitute bearing surfaces 11A and 11B.

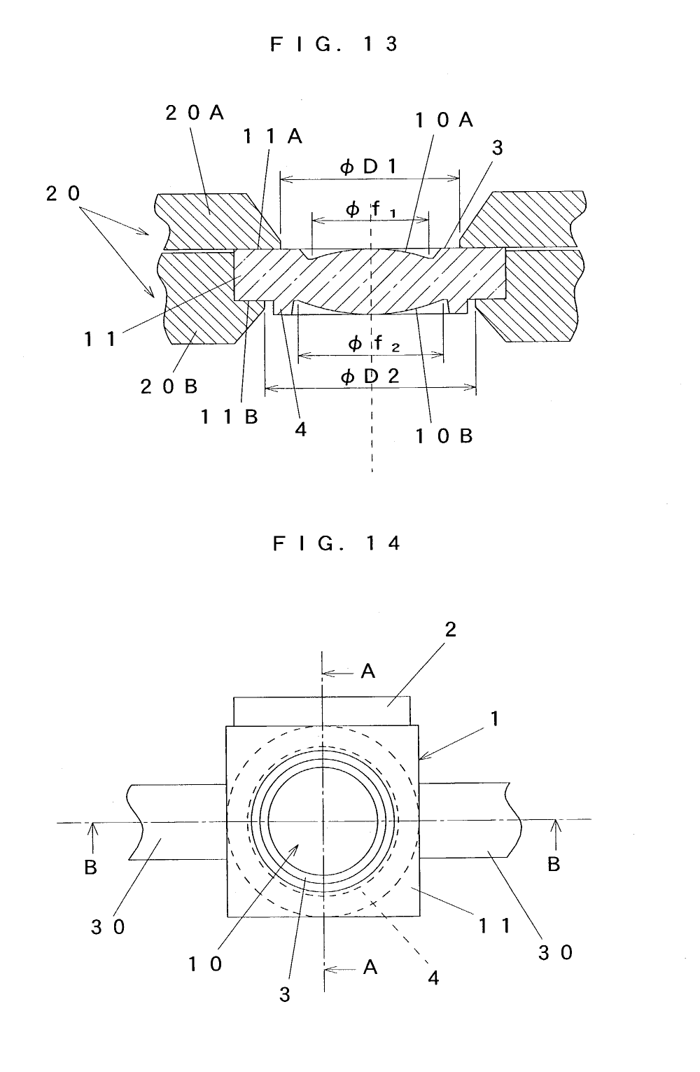

The small lens 1 for optical use formed by injection molding from the plastic material in this manner undergoes coating of its optically functional faces 10A and 10B for the prevention of reflection, for instance. In this coating process, the bearing surfaces 11A and 11B of the flange 11 of the lens 1 are held between and supported by a pair of plates 20A and 20B of coat jigs 20 (see FIG. 13). At this time, with the bore of the hole in the plate 20A, one of the paired plates 20A and 20B, being represented by D₁ and that of the other plate 20B by D₂, the diameter of the optically functional face 10A by f₁ and that of the optically functional face 10B by f₂, there can be allowed a sufficient gap between f₁ and D₁, and so can be between f₂ and D₂, with the result that the coat in the peripheries of the optically functional faces are not shadowed when the optically functional faces 10A and 10B are coated. Coating of the optically functional faces 10A and 10B is usually accomplished by vapor deposition. A plurality of holes to support a plurality of lenses 1 are bored in the pair of plates 20A and 20B, and each of the lenses 1 is set into one or another of the holes in the plate 20B in a state in which the plate 20A is opened. By closing the plate 20A, the lens 1 is held between the plates 20A and 20B. In this state, the coat jigs 20 are brought into the vapor deposition chamber, wherein vapor deposition material evaporating from the vapor deposition source is deposited on the optically functional faces 10A and 10B.

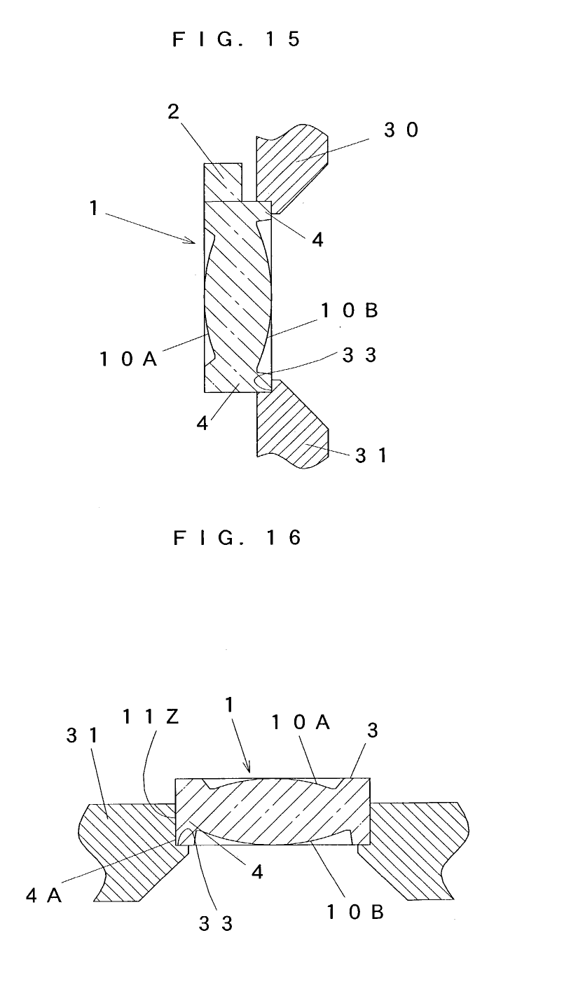

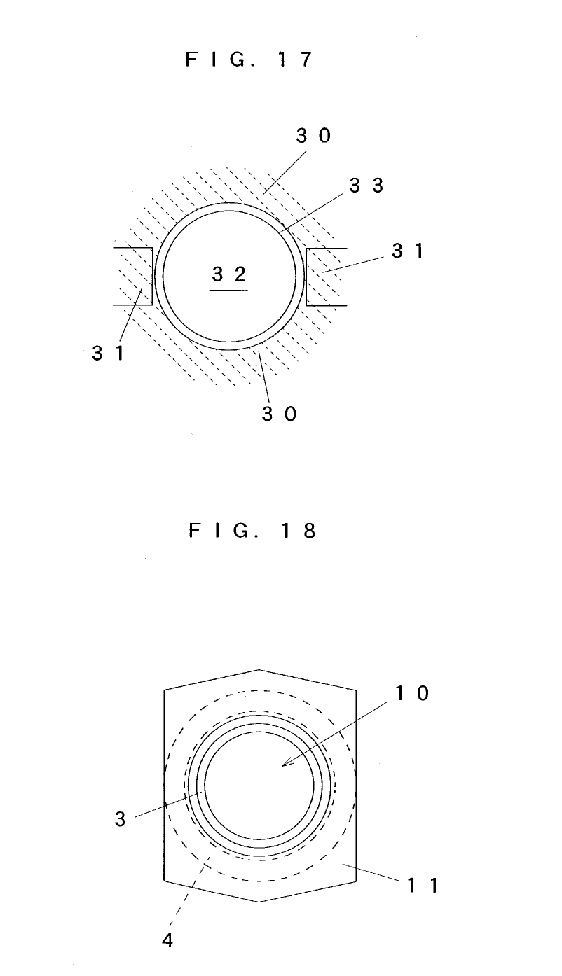

FIG. 14 shows a plan of the lens 1 mounted on a lens mount 30 within the lens barrel. A section along a line A-A in this FIG. 14 is as shown in FIG. 15, and represents the position in which the convex 4 of the round body of the lens 1 is mounted. FIG. 16 shows a section of FIG. 14 along a line B-B, wherein rotation regulating convexes 31 are formed integrally with the lens mount 30 and have a function to restrain rotation. The outer circumferential part of the convex 4 formed on the lens 1, denoted by sign 4A, enables the lens 1 to be positioned by utilizing this circumference, namely the circular part. A side of the flange 11, positioned above this convex 4 in the drawing is linear, and the rotation regulating convexes 31 come into contact with this linear part 11Z to prevent the lens 1 from turning within the lens barrel. Incidentally, at the time of trying to position the lens 1, the part matching the gate 2 should be brought into a prescribed position.

FIG. 17 shows a horizontal section of the lens barrel deprived of the lens 1 in the state of FIG. 16. Between the paired rotation regulating convexes 31, right and left, there is a hole 32, and on the circumference of this hole 32 is formed a stepped part 33, the convex 4 of the lens 1 being mounted on this stepped part 33.

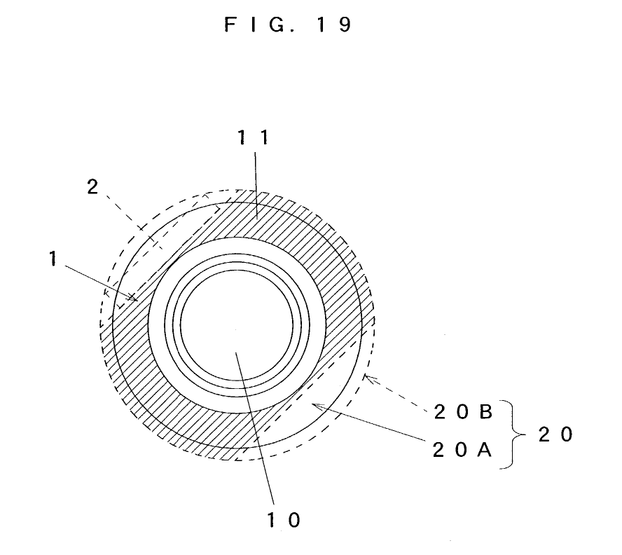

To add, although the aforementioned flange 11 is formed in a rectangle, or a square in this particular embodiment, its circumferential shape can as well be formed in a hexagon as shown in FIG. 18, or in a pentagon or a triangle, too. Or, as shown in FIG. 19, the circumferential shape of the flange 11 need not be hexagonal, but forming at least two sides of it straight would also be adequate. The gate 2 can be formed on one of the straight sides. In the injection molding of a plastic lens, with the flow (orientation) of resin taken into consideration, the greater the gate width, the more favorable the optical characteristics of the resultant lens. Therefore it is preferable to provide the gate 2 on one of the straight sides. Furthermore, since this would make the protrusion in the radial direction smaller, there will be no dependence on the shape of the lens barrel, the coat jigs or the like. Moreover, the absence of prominent protrusion makes it possible for the coat jigs to accommodate a correspondingly greater number of lens, and therefore the productivity will also rise. However, where it is imperative to use two linear sides to restrain rotation, the orientation would not pose so much of a problem because the gate 2 can secure a width substantially equal to the lens diameter even if the gate 2 is formed on a curvilinear face. Therefore, if the lens barrel, the coat jigs or the like provide a part into which the protrusion of the gate can escape, the gate 2 can as well be arranged there. Where the circumferential shape of the flange 11 is polygonal, one side of it can be formed into the gate 2. FIG. 19 shows a plan of a state in which this lens is supported by the coat jigs 20.

What constitutes the largest circle on the outside of the lens per se 10 is the convex 4 in this embodiment, and the flange 11 is formed outside this round body. Since extension of equally long parts of the flange 11 from the whole circumference of this round body would be a waste of the material, where the flange 11 is rectangular, it is so configured that its four sides be tangent on the outermost circle (the outer circumference of the convex 4) and each corner be supported on one of the coat jigs 20. Even where each side of the flange 11 is not tangent on the round body, the rectangular flange 11 should be so formed that each of its sides be close to a tangent on the circle.

Or in the flange 11 in which at least two sides are linear, these two sides should be linear parts to which tangents on the round body are close.

Although the lens 1 is supposed to be formed by injection molding of plastic material in the above-described embodiment of the present invention, this process can undoubtedly be applied as well to glass lenses formed by pressing molten glass.

What is claimed is:

1. A small lens for optical use around which lens per se is formed a flange,
wherein either the circumferential shape of the flange is formed polygonally on a plane orthogonal to an optical axis or at least two sides of the flange are formed linearly in a length equal to or longer than a diameter of the lens per se.

2. The small lens for optical use, as set forth in claim 1, wherein the circumferential shape of said flange is a rectangle, whose four sides are either tangents on or close to tangents on a circle of the lens per se or of a round body around it.

3. The small lens for optical use, as set forth in claim 1 or 2, formed by injection molding of plastic material.

4. The small lens for optical use, as set forth in claim 1 or 2, wherein an overall diameter is not more than 2 mm.

5. A small lens for optical use around which lens per se is formed a flange,
wherein either a circumferential shape of the flange is formed polygonally on a plane orthogonal to an optical axis or at least two sides of the flange are formed linearly in a length equal to or longer than a diameter of the lens per se, and
the lens is formed by injection molding of plastic material and one side of the polygonal shape or one linear side of said flange is used as a gate for injection molding.

6. The small lens for optical use, as set forth in claim 5, wherein the circumferential shape of said flange is a rectangle, and whose four sides are either tangents on or close to tangents on the circle of the lens per se or of a round body around it.
